(19) United States
(12) Patent Application Publication
(10) Pub. No.: US 2007/0198748 A1
(43) Pub. Date: Aug. 23, 2007

(54) POWER LINE COMMUNICATION HUB SYSTEM AND METHOD

(75) Inventors: Julius Ametsitsi, Marysville, WA (US); Robert J. Jaap, Duvall, WA (US); Frank Chin-Hwan Kim, Woodinville, WA (US); Nelson V. Taylor, Bothell, WA (US); Ross Goldman, Bothell, WA (US)

Correspondence Address: DAVIS WRIGHT TREMAINE, LLP, 1201 Third Avenue, Suite 2200, SEATTLE, WA, 98101-3045, US

(73) Assignee: LEVITON MANUFACTURING CO., INC., Little Neck, NY (US)

(21) Appl. No.: 11/670,399

(22) Filed: Feb. 1, 2007

Related U.S. Application Data
(60) Provisional application No. 60/763,980, filed on Feb. 1, 2006.

(51) Int. Cl. G06F 15/16; G05B 11/01; G08B 1/08

(52) U.S. Cl. 709/249; 709/250; 340/310.11; 340/538

(57) ABSTRACT

A power line communication (PLC) hub incorporates multiple network communication media and services for devices. Implementations can be plugged into an electrical outlet to furnish a single point for both electrical power and network connectivity. Each of the electrical outlets is tied through an electrical distribution system to a network through a conventional PLC bridge to provide network connectivity through the electrical distribution system using PLC technology. The PLC outlet hub can include various combinations of applications and/or services including Voice Over Internet Protocol (“VoIP”) gateway, media server, Internet router/gateway, Local Area Network (“LAN”), both wired and wireless voice and video conferencing capability, including a VoIP, Voice over WiFi (“VoWiFi”), Power Over Ethernet (“PoE”), Wireless 802.11a/b/g/n capability and (Wireless Universal Serial Bus “WUSB”/Ultra Wide Band “UWB”) wireless connectivity, and Blue Tooth. Versions of the PLC outlet hub can have an Ethernet IEEE 802.3 family (such as IEEE 802.3af) compliant power supply to furnish power to PoE enabled devices.

### CROSS REFERENCE TO RELATED APPLICATION

This application claims priority benefit of provisional application Ser. No. 60/763,980 filed Feb. 1, 2006, the content of which is incorporated in its entirety.

### BACKGROUND OF THE INVENTION

1. Field of the Invention

The present invention is directed generally to network and electrical power distribution including power line communication.

2. Description of the Related Art

Various forms of conventional network communication can be sent through different types of network media such as network cable, radio waves, and power lines. Unfortunately, situations can arise where one type of network media is available whereas another type of network media would be preferred based upon factors such as type of end-user or other devices available. Other times, network media of an undesired capacity or no network media may be available to service end-user and other devices thereby encouraging burdensome projects as attempted remedies.

As further background, aspects of conventional network media will follow in remaining portions of this description of the related art, but is not intended to limit the invention as claimed since the invention is not limited except as by the appended claims.

The transmission of data through power lines, initially at relatively low rates of data transmission, is an established, viable technology. Recent developments in broadband power line communication systems (“PLC”), also known as broadband power line (“BPL”) systems, have increased the rate of data transmission significantly to enable the transmission of both electrical power and high-speed data through pre-existing power lines.

Today, PLC technology enables end users, in both the residential and the integrated enterprise network environment, to transmit a wide variety of applications and services over established power lines. These applications and services include, among other things, transmission of voice-over-internet-protocol (“VoIP”), multimedia data and services, and remotely controlled residential applications.

Wireless 802.11 Technology Standards

The 802.11b and 802.11g standards use 2.4 GHz band and operate under Part 15 of the Federal Communications Commission (“FCC”) rules and regulations.

IEEE 802.11—applies to wireless Local Area Networks (“LAN”) and provides 1 or 2 Mbps transmission in the 2.4 GHz band using either frequency hopping spread spectrum (“FHSS”) or direct sequence spread spectrum (“DSSS”).

IEEE 802.11a is an extension to 802.11 that applies to wireless LANs permits transmission up to 54 Mbps in the 5 GHz band. The 802.11a standard covers most common communications at 6 Mbps, 12 Mbps, or 24 Mbps. 802.11a uses an Orthogonal Frequency Division Multiplexing (“OFDM”) encoding scheme rather than FHSS or DSSS. The specification applies to wireless Automated Teller Machine (“ATM”) systems and is used in access hubs.

IEEE 802.11b—often called WiFi. The modulation used in 802.11 has historically been phase-shift keying (“PSK”). The modulation method selected for 802.11b is known as complementary code keying (“CCK”), which allows higher data speeds and is less susceptible to multipath-propagation interference. 802.11b has a maximum raw data rate of 11 Mbit/s and uses the Carrier Sense Multiple Access with Collision Avoidance (“CSMA/CA”) access method. 802.11b is typically used in a point-to-multipoint configuration, has an indoor range of 30 m at 11 Mps and at 90 m can operate up to 1 Mbps. 802.11b cards will operate at 11 Mbit/s, scale back to 5.5, then 2, then 1 Mbit/s if signal quality is poor. Extensions have been made to the 802.11b protocol to increase speed to 22, 33, and 44 Mbit/s, are proprietary and have not been endorsed by the IEEE.

IEEE 802.11g applies to wireless LANs and provides 20+ Mbps in the 2.4 GHz band. This is the most recently approved standard and offers wireless transmission over relatively short distances at up to 54 Mbps compared with the 11 Mbps of the 802.11b standard. Like 802.11b, 802.11g operates in the 2.4 GHz range and is thus compatible with it. The modulation scheme used in 802.11g is OFDM for data rates of 6, 9, 12, 18, 24, 36, 48, and 54 Mbit/s, and, like the 802.11b standard, reverts to CCK for 5.5 and 11 Mbps and Differentially-Encoded Binary Phase Shift Keying (“DBPSK”)/Differentially-Encoded Quadrature Phase Shift Keying (“DQPSK”) +DSSS for 1 and 2 Mbps.

With IEEE 802.11n data throughput is estimated to reach a theoretical rate of 540 Mbps. 802.11n builds upon previous 802.11 standards by adding multiple-input multiple-output (“MIMO”). MIMO uses multiple transmitter and receiver antennas which allow for increased data throughput using spatial multiplexing and increased range by exploiting the spatial diversity.

IEEE 802.15.1 (Blue Tooth) is short-range radio technology for communications among Internet devices and between devices and the Internet. 802.15.1 facilitates data synchronization between Internet devices and other computers. Products with 802.15.1 technology must be qualified and pass interoperability testing by the Bluetooth Special Interest Group prior to release. Bluetooth's founding members include Ericsson, IBM, Intel, Nokia and Toshiba. Transmission speed up to 2.1 Mbps, up to 100M range (depends on the classification), has a low power consumption rate because of a reduced duty cycle.

The IEEE 802.15.3a UWB (Ultra Wideband) standard includes two technology proposals for UWB: the OFDM proposal of the Multiband OFDM Alliance (“MBOA”) and the direct sequence (“DS”) proposal. 802.15.3a is the consolidation of 23 UWB PHY specifications into two proposals: 1) Multi-Band Orthogonal Frequency Division Multiplexing (“MB-OFDM”) UWB, supported by the WiMedia Alliance; 2) and Direct Sequence—UWB (“DS-UWB”), supported by the UWB Forum. UWB is a radio frequency platform that personal area networks (“PAN”) can use to wirelessly communicate over short distances at high speeds.

Ultra Wide Band is a wireless communications technology that can currently transmit data at speeds between 53.3 to 480 Mbps and, eventually, up to 1 Gbps. UWB can transmit ultra-low power radio signals with very short electrical pulses, often in the picosecond (1/1000th of a nanosecond) range, across all frequencies at once. UWB receivers must translate these short bursts of noise into data by listening for a familiar pulse sequence sent by the transmitter. UWB has low power requirements and can be very difficult to detect and regulate. Because it spans the entire frequency spectrum (licensed and unlicensed), it can be used indoors and underground.

PLC (Power Line Communications) works by transmitting high frequency data signals through the same power cable network used for carrying electricity power to household users. Such signals cannot pass through a transformer. This requires coupler devices that combine the voice and data signals with the low-voltage supply current in the local electrical panel to input the PLC signal onto the power grid. Bridging devices are used to filter out the voice and data signals and to feed them to the various applications.

PLC applied “in-building” in commercial environments is somewhat new. PLC takes advantage of an extensive pre-existing communications infrastructure (electrical grid), thus eliminating the need for building redundant facilities. Power lines can carry signals for long distances without requiring regeneration. There is no topology limitation for power lines.

There are several speed technologies in use. HomePlug AV is “fully compliant” with the HomePlug 1.0 specification and is rated at 200 Mbps. HomePlug 1.0 is rated for 14 Mbps and HomePlug 1.0 Turbo is rated for 85 Mbps. Generally, 85 Mbps is the lowest recommended level. A new chipset offers the higher bandwidth performance necessary to drive next-generation home entertainment applications such as standard-definition video (but not high-definition), Internet Protocol Television “IPTV” and whole-house audio. HomePlug AV technologies will support transmission rates in excess of 100 Mbps-up to 200 Mbps, allowing transmission of multiple audio, standard-definition video and High Definition Television “HDTV” video streams over power lines. This higher speed version will be double the speed of 802.11n compliant technology and will boost this technology into contention with wireless and copper/fiber systems.

VoIP (Voice Over IP) is a category of hardware and software that enables the use of the Internet Protocol (IP)as the transmission medium for telephone calls by sending voice data in packets using IP rather than traditional circuit transmissions of the Public Switched Telephone Network (“PSTN”). An advantage of VoIP is that the telephone calls over the Internet do not result in a surcharge beyond what the user is paying for Internet access.

Use of PLC systems that incorporate multiple transmission protocols for efficient transmission of a variety of data types is increasing in a number of different environments, including conference and board rooms, class rooms, training facilities, call centers, temporary phone banks and trade shows. The present invention, a compact, portable, multiservice, universal connectivity adapter, is a novel device that is an essential component of a PLC system designed to meet the increasing demand for efficient communication of data over established power lines in a wide variety of environments.

### BRIEF DESCRIPTION OF THE SEVERAL VIEWS OF THE DRAWING(S)

FIG. 1 is a schematic block diagram of an implementation of a power line communication (PLC) outlet hub system as communicatively linking devices to a network.

FIG. 2 is a schematic block diagram of a plurality of the PLC outlet hub in an exemplary topology implementation.

FIG. 3 is a schematic block diagram of an exemplary implementation of the PLC outlet hub.

FIG. 4 is a schematic block diagram of an exemplary implementation of the PLC bridge used in the PLC outlet hub.

FIG. 5 is a perspective view of a first exemplary implementation of the PLC outlet hub.

FIG. 6 is a perspective view of the first implementation of FIG. 5 showing wireless communication module detail.

FIG. 7 is a side elevational view of the first implementation of FIG. 5 with a remote display.

FIG. 8 is a perspective view of the first implementation of FIG. 5 with two remote displays.

FIG. 9 is a perspective view of the first implementation of FIG. 5 with additional audio-visual features.

FIG. 10 is a perspective view of the first implementation of FIG. 9 with a retractable keypad shown in the extended position.

FIG. 11 is a perspective view of the first implementation of FIG. 10 with the retractable keypad shown in the retracted position.

FIG. 12 is a top plan view of the first implementation of FIG. 5.

FIG. 13 is a side elevational view of the first implementation of FIG. 5.

FIG. 14 is a bottom plan view of the first implementation of FIG. 5.

FIG. 15 is a perspective view of a second implementation of the PLC outlet hub of FIG. 1.

FIG. 16 is a side elecvational view of the second implementation of FIG. 15.

FIG. 17 is a top plan view of the second implementation of FIG. 15.

FIG. 18 is a bottom plan view of the second implementation of FIG. 15.

FIG. 19 is a perspective view of a third implementation of the PLC outlet hub of FIG. 1.

FIG. 20 is a side elecvational view of the third implementation of FIG. 19.

FIG. 21 is a top plan view of the third implementation of FIG. 19.

FIG. 22 is a bottom plan view of the third implementation of FIG. 19.

### DETAILED DESCRIPTION OF THE INVENTION

As will be discussed in greater detail herein, a power line communication (PLC) hub incorporates multiple network communication media and services for end-user and other devices. Implementations include compact, portable versions, each of which can be plugged into an electrical outlet to furnish a single point for both electrical power and network connectivity to locations within business, industrial, commercial, office, school, research, worship, home, entertainment, and other facilities. For instance, a location could be a conference room table, an office workspace, a lab bench, a reference desk or other planar surface. Other implementations are configured for other sorts of positioning.

Each of the electrical outlets is tied through an electrical distribution system (including single, dual, and three phase distribution systems) located in a facility. The electrical distribution system is linked to a network through a conventional PLC bridge to provide network connectivity through the electrical distribution system using PLC technology. The PLC outlet hub can be upgraded to take advantage of advances in technology and standards related to PLC and network communication media.

By being linked to the network through the wall outlet of the electrical distribution system and the PLC bridge, the PLC outlet hub can include various combinations of applications and/or services. These applications and services can include a VoIP gateway, media server, Internet router/gateway, LAN, both wired and wireless voice and video conferencing capability, including VoIP, Voice over WiFi (“VoWiFi”), Power Over Ethernet “PoE”, Wireless 802.11a/b/g/n capability and WUSB/UWB wireless connectivity, Bluetooth and/or other applications and/or services.

Multimedia connectivity can be provided between end-user and other devices connected through other ones of the PLC outlet hub to be included within the scope of a PLC enabled electrical distribution system. Versions of the PLC outlet hub can have an Ethernet IEEE 802.3 family (such as IEEE 802.3af) compliant power supply to furnish power to PoE enabled devices such as VoIP telephones through versions of IEEE 802.3 compliant cabling.

From a functional standpoint, implementations can be configured to include three functional modules: 1) a power module; 2) an audio-visual module; and 3) a data module. From a structural standpoint, implementations can be configured to include a layered approach having multiple tiers.

The layered approach can include three-tiered implementations having a 1) power tier; 2) a network tier; and 3) a wireless tier described as follows and further depicted below. The power tier can be arranged on the bottom tier of the PLC outlet hub 100 and include 120 V, three hole (National Electrical Manufacturers Association (“NEMA”)) AC outlets, allocated amongst multiple bays, and equipped to supply power to any AC rated electronic devices.

The network tier can include networking components that connect to one or more conventional LANs through PLC technology. The network tier can include the Ethernet IEEE 802.3 family of LAN interfaces configured as RJ45 jacks, allocated amongst multiple bays, with PoE (four channel), VoIP and/or Ethernet capability available at some or all jacks. The network tier can also include PLC line driver/controllers comprised of a custom multi-port system on a chip (“SOC”) with protocol adaptation, transparent bridging, media access control (“MAC”) and line interface drivers for network integration.

The wireless tier can be located in a top portion of the PLC outlet hub 100 and can include multi-protocol wireless (IEEE 802.11a/b/g/n(future)) and wireless universal serial bus (“WUSB”) connectivity, with one or more enclosed antenna. Access radio modules of the wireless tier can be upgraded in the field by swapping out the modules. Current wireless technologies supported include IEEE 802.11 series (including LAN/WiFi/WLAN), IEEE 802.15.1 (Blue Tooth), IEEE 802.15.3a (PAN), MBOA/WiMedia Alliance System (Wireless USB), and proprietary wireless protocols.

The PLC outlet hub 100 can include the following exemplary features: 1) Wired/Wireless Voice Conferencing Terminal: the PLC outlet hub 100 can be used as a voice conferencing telephone system with PLC or UWB wireless technology options. 2) Voice conferencing may be implemented with installed microphones, speakers, and dialing system with retractable control keypad. 3) Video Conferencing Terminal with Remote/Wall Mounted Liquid Crystal Display (“LCD”) Panels: the PLC outlet hub 100 can be configured as a video conferencing system with installed speakers, microphones and cameras, projecters, a switching device for manual or automatic control and wall mounted or stand alone wired/wireless LCD panels (data signal and control via the UWB wireless link) for conference room applications.

Implementations can be constructed to include a plastic enclosure or housing or other such structural material with various profiles such as circular, hexagonal, some other polygonal, or other profile and also include multiple bay configurations. Some implementations can have profiles including approximately less than or approximately equal to one-foot diameter profiles with less than six-inch height profiles for convenient placement. Other implementations can be of other dimensional thresholds such as six-inch or two-foot width or diameter thresholds and three-inch or one-foot height thresholds.

Implementations can include multiple feet incorporated into a base made from such material as Santoprene and layered with anti-slip material that are appropriately placed to ensure stability of PLC outlet hub. Implementations have at least one detachable power cord, which includes a three-prong plug to be coupled with an electrical outlet that is part of a PLC distribution system.

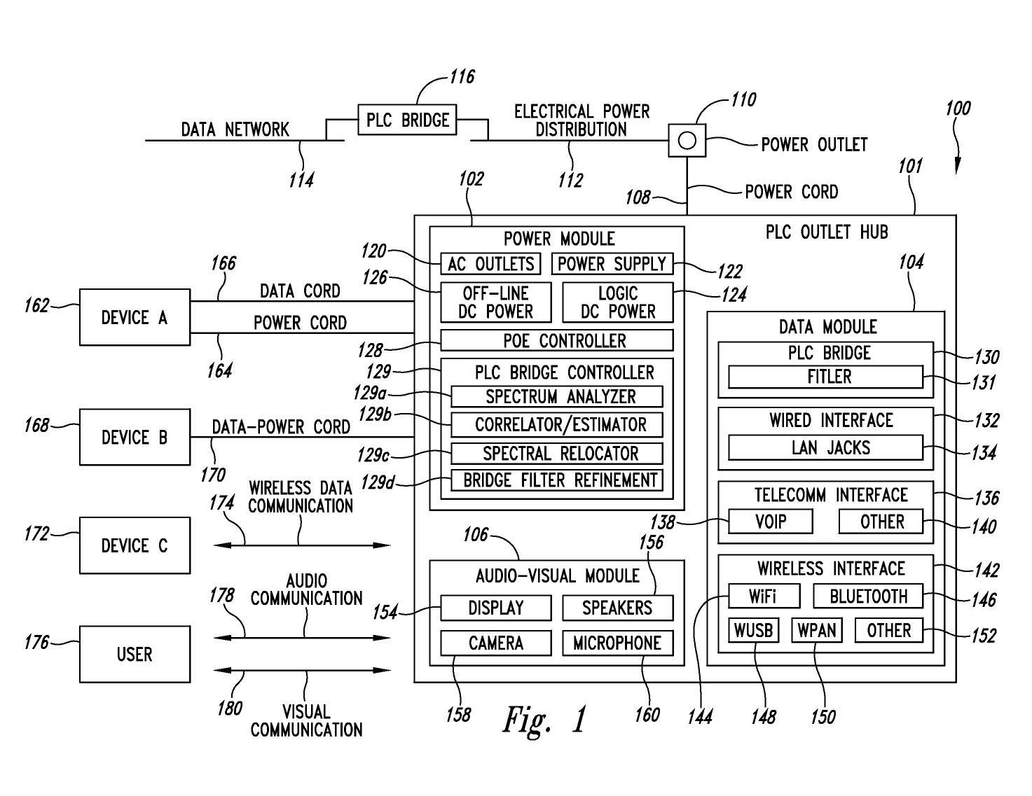

An implementation of a PLC outlet hub 100 is shown in FIG. 1 as having a power module 102, a data module 104, and an audio-visual module 106. The PLC outlet hub 100 is electrically coupled through a power cord 108 to an electrical outlet 110, such as found on a room wall or elsewhere. The electrical outlet 110 is part of an electrical power distribution 11 2 device, as can be found in a building or other facility. The electrical power distribution 11 2 is communicatively linked to a data network 114 through a conventional PLC bridge 116. As discussed above, the PLC bridge 116 allows connectivity to the data network 114 through the electrical power distribution 112. The power module 102 includes AC outlets 120, a power supply 122, a logic DC power 124, and a PoE controller 128. The power module 102 further has a PLC bridge controller 129 that includes a spectrum analyzer 129a, a correlator/estimator 129b, a spectral relocator 129c, and a bridge filter refinement 129d.

The data module 104 includes a PLC bridge 130, a wired interface 132 with among other things LAN jacks 134, such as RJ45 for versions of IEEE 802.3 Ethernet, a telecommunication interface 136 including VoIP 138 and other telecommunication connectivity 140, and a wireless interface 142 with one or more versions of WiFi 144, Bluetooth 146, WUSB 148, WPAN 150, and other 152 connectivity portions.

The PLC bridge 130 includes a filter 131, such as a harmonic filter, for filtering out undesired signals and undesired noise from signals being sent to the electrical distribution system 112. The PLC bridge controller is configured to act as a cognitive agent in observing undesired signals present and determining proper spectrum areas to be used accordingly. The spectrum analyzer 129a of the PLC bridge controller 129 are electrically coupled to the AC outlets 120 and the LAN jacks 134 to determine the presence of undesired noise and undesired signals present on the electrical distribution system going through the LAN jacks and present on the AC outlets coming from one or more devices each electrically connected to a different one of the AC outlets 120.

The correlator/estimator 129b determines the current spectral mask of the PLC bridge 130. The spectral relocator 129c instructs the PLC bridge 130 to change the frequency spectrum used for outputted signals by the PLC bridge based upon analysis by the spectrum analyzer 129a of the undesired noise and undesired signals present on the electrical distribution system. The bridge filter refinement 129d instructs the filter 131 of the PLC bridge 130 to filter out undesired noise and undesired signals determined by the spectrum analyzer 129a to be present from the AC outlets 120. Implementations include substantially real time performance for tracking changes in undesired signals.

As depicted for illustration, a device A 162 is connected to the PLC outlet hub 100 with power cord 164 connected to one of the AC outlets 120 to receive electrical power and with data cord 166 connected to one of the LAN jacks 134 to be networked with the data network 114. A device B 168 is connected to the PLC outlet hub 100 with data-power cord 170 connected to one of the LAN jacks 134 that is enabled by the PoE controller 128 to receive power through the PoE enabled LAN jack. A device C 172 sends and receives wireless data communication 174 with the wireless interface 142.

A user 176 sends audio communication 178 to the microphone 160 and receives the audio communication from the speakers 156. The user 176 sends visual communication 180 to the camera 158 and receives the visual communication from the display 154. Although FIG. 1 depicts single instances of each of the device A 162, the device B 168, the device C 172, and the user 176, other examples and implementations can have other numbers of these or other devices communicating with the PLC outlet hub 100.

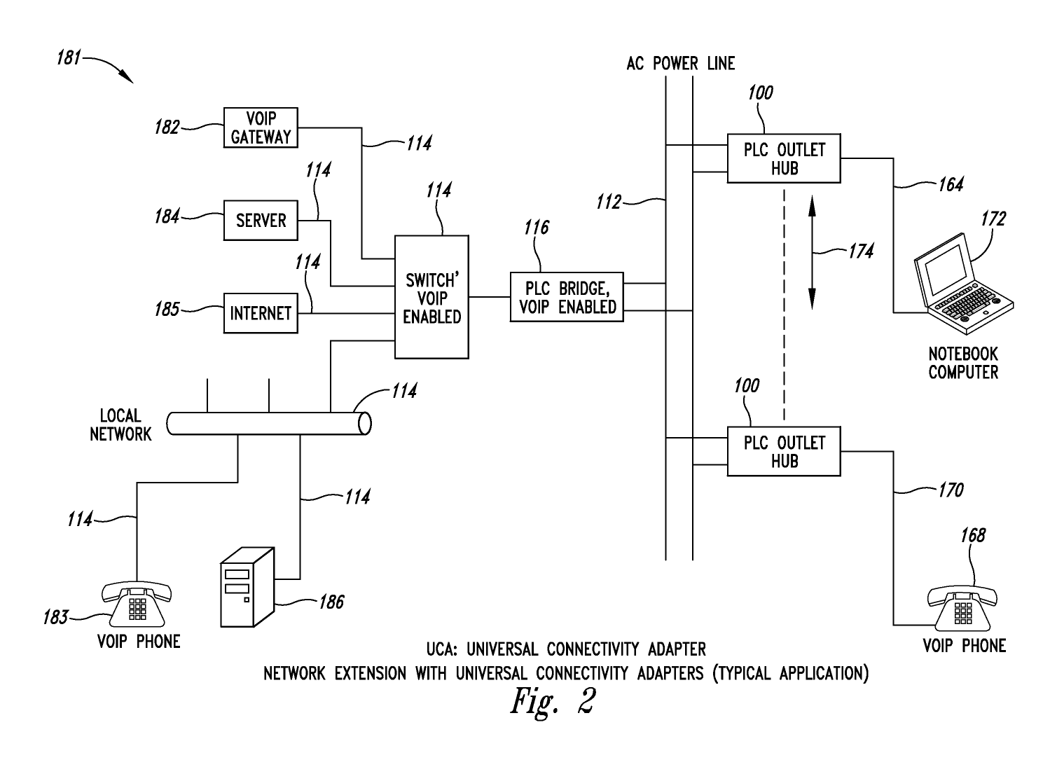

An exemplary topology 181 incorporating the PLC outlet hub 100 is depicted in FIG. 2 as illustrating an instance of the device B 168 as a VoIP phone communicating through the PLC outlet hub, the electrical power distribution 112, the PLC bridge 116, and the data network 114 to a VoIP gateway 182 and a VoIP phone 183. The exemplary topology 181 further illustrates an instance of the device C 172 as a notebook computer communicating through the PLC outlet hub 100, the electrical power distribution 112, the PLC bridge 116, and the data network 114 to a server 184, an Internet access 185, and a workstation 186.

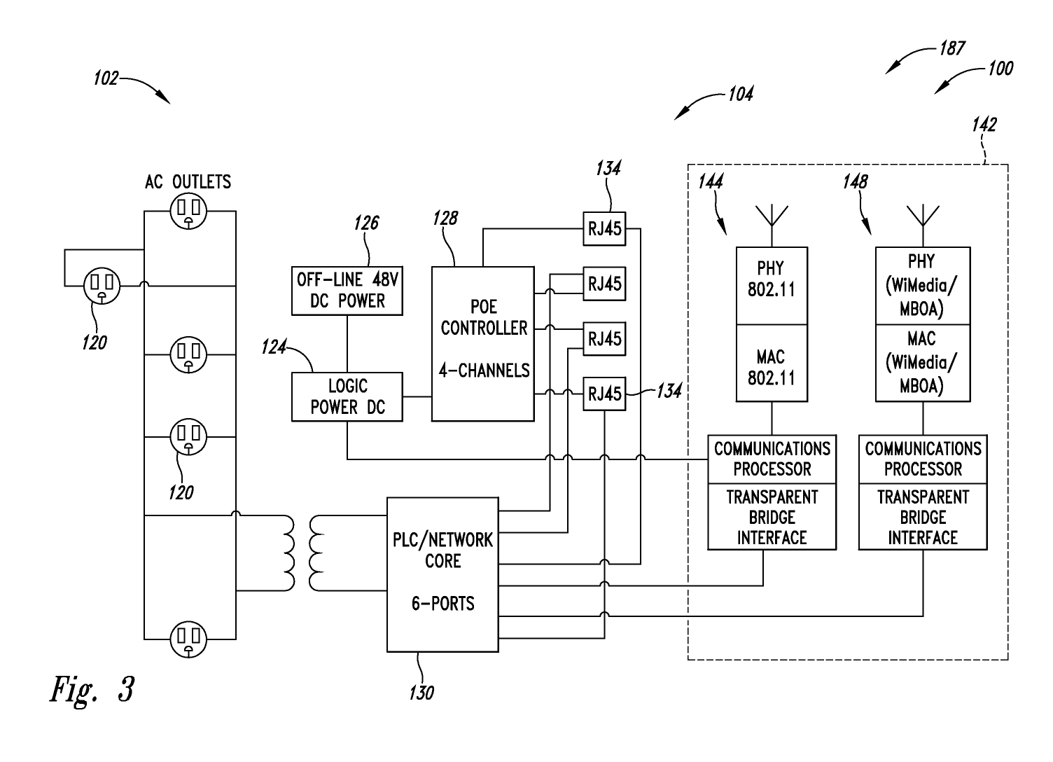

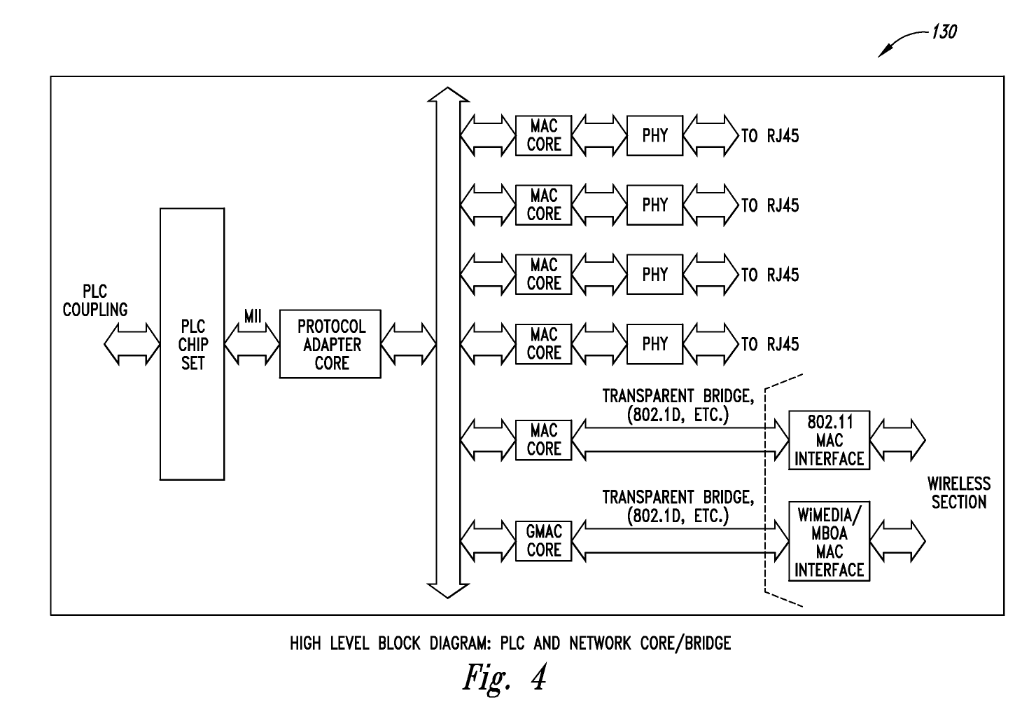

An exemplary implementation 187 of the PLC outlet hub 100 is depicted for illustrative purposes in FIG. 3 showing detail of a version of the WiFi connectivity portion 144 and a version of the WUSB connectivity portion 148. The exemplary implementation 187 of the PLC outlet hub 100 further shows detail of versions of portions of the power module 102 and the data module 104. FIG. 4 depicts portions of an exemplary protocol implementation for the PLC bridge 130.

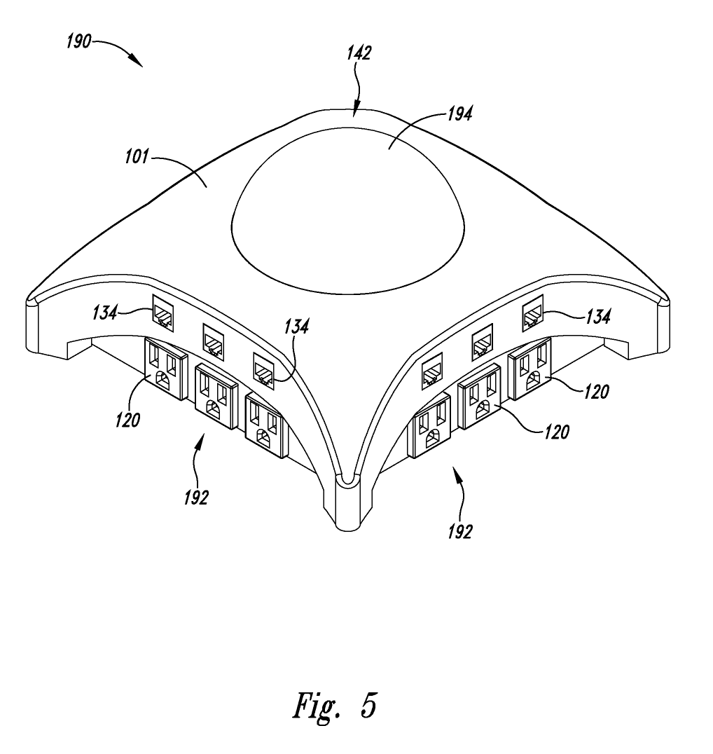

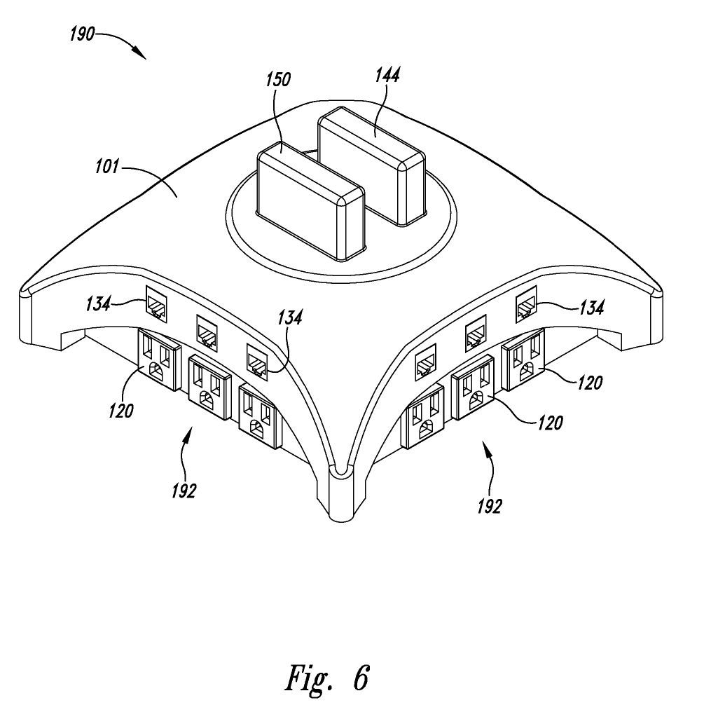

A first exemplary structural implementation 190 is depicted in FIG. 5 as a quadragonal structure having four outward facing, opposing bays 192 each with a plurality of the AC outlets 120 and a plurality of the LAN jacks 134 arranged in separate rows in a vertical pairing of one AC outlet to one LAN jack. The first implementation 190 has a dome 194 covering the wireless interface 142. The dome 194 can be removed as shown in FIG. 6 to access various connectivity portions of the wireless interface 142 depicted as having two connectivity portions each of a particular version (the WiFi connectivity portion 144 and the WPAN connectivity portion 150) but can be other versions and quantities in other implementations. The connectivity portions are depicted in FIG. 6 as being removably engaged with the remaining portions of the PLC outlet hub 100 to provide ability for upgrade or to change wireless services as desired.

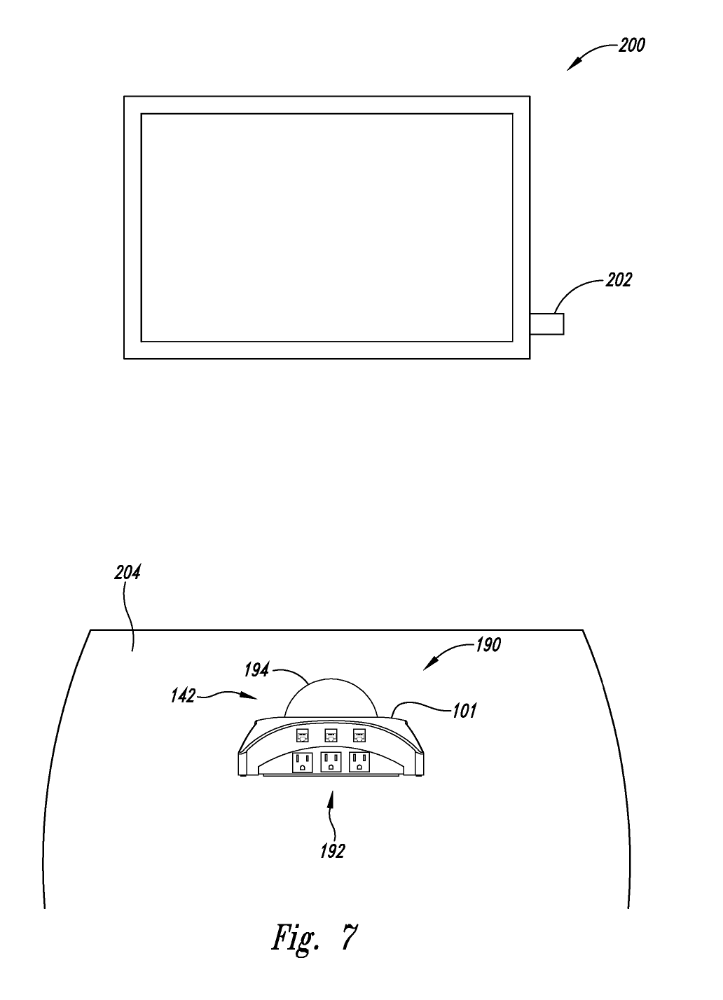

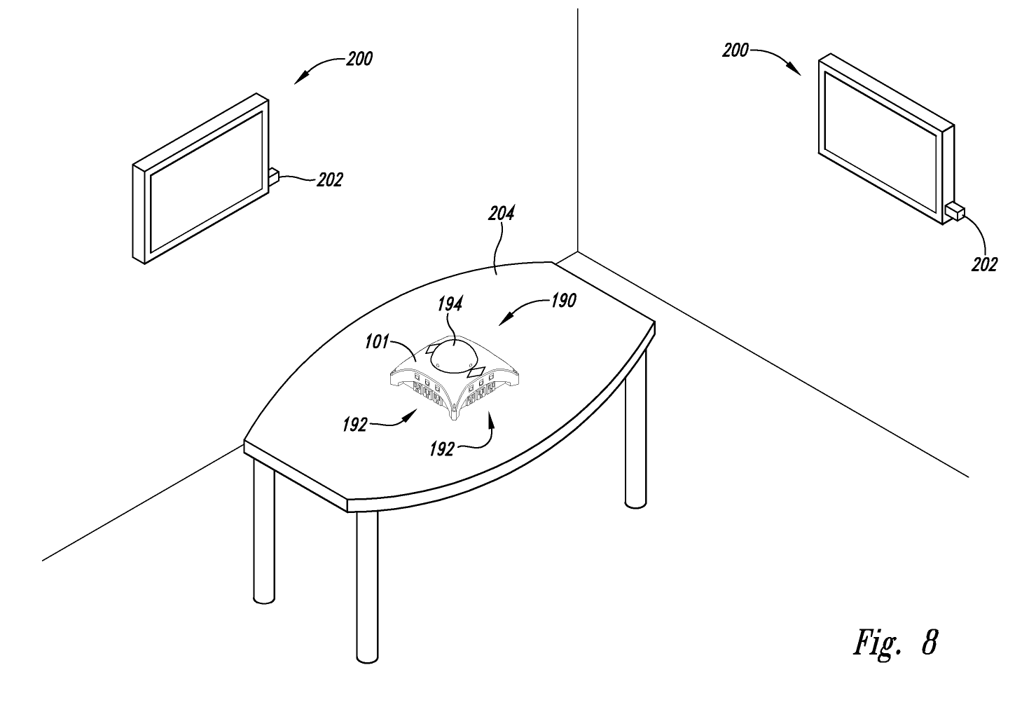

The first implementation 190 is shown in FIG. 7 communicating with a remote display 200 via a WUSB connectivity interface 202 incorporated into the remote display. The display portion 154 of the audio-visual module 106 of the PLC outlet hub 100 shown in FIG. 1 can send visual data through the WUSB connectivity portion 148 of the wireless interface 142 to be received through the WUSB connectivity interface 202 and displayed by the remote display 200. Similarly, the first implementation 190 is shown in FIG. 8 as using two of the remote displays 200.

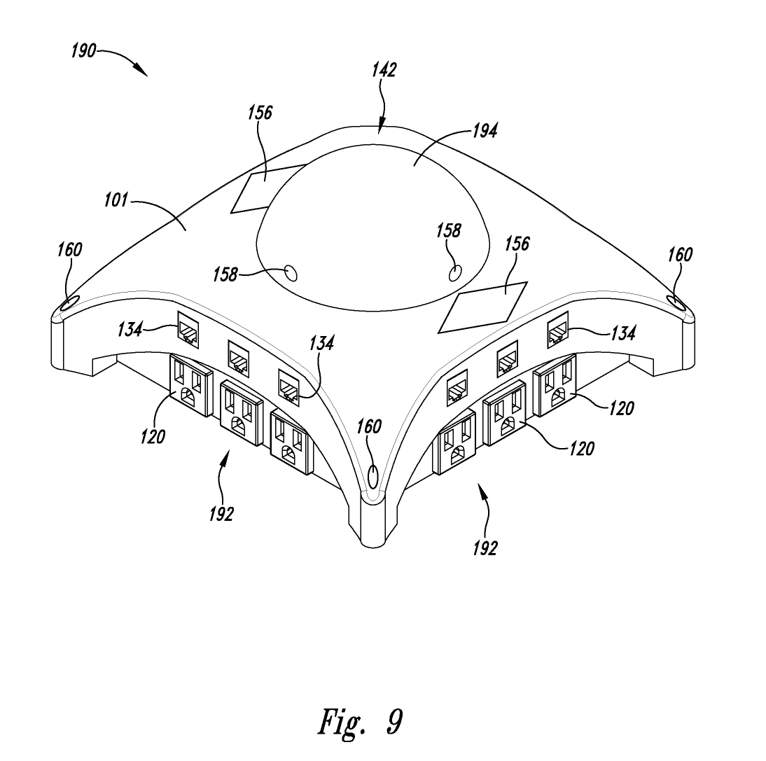

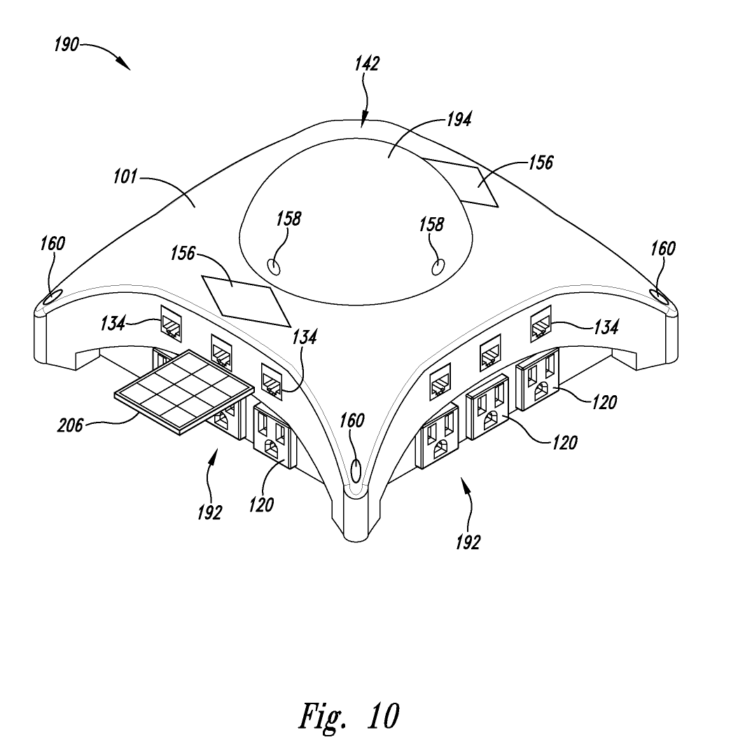

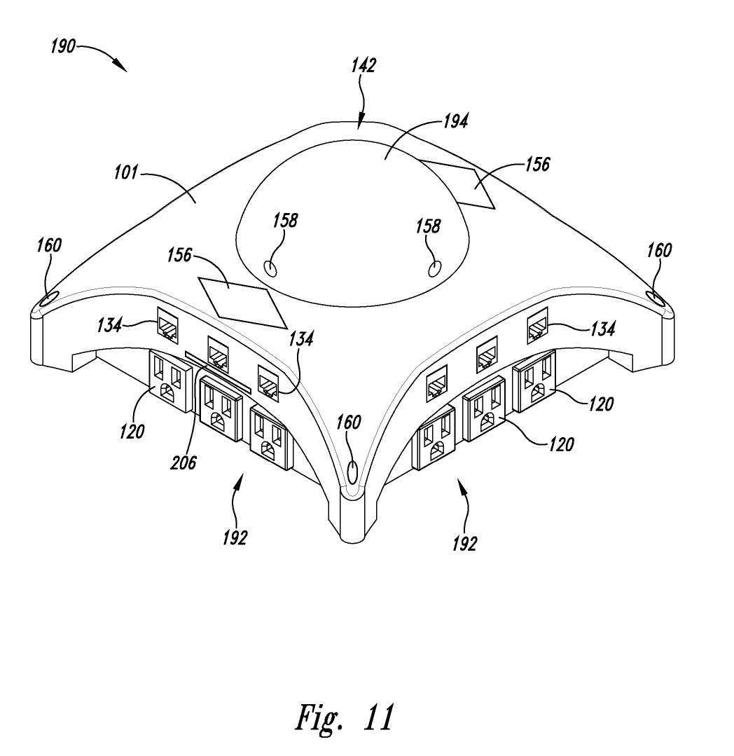

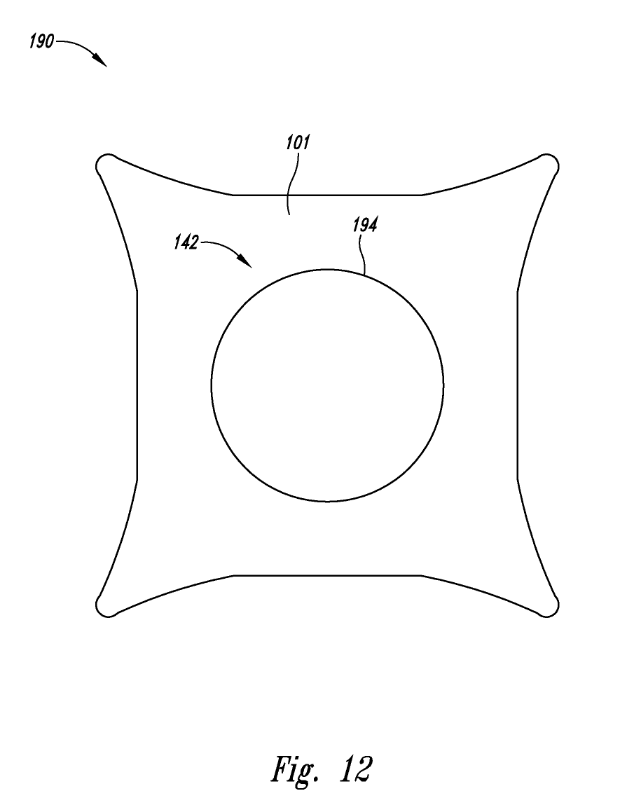

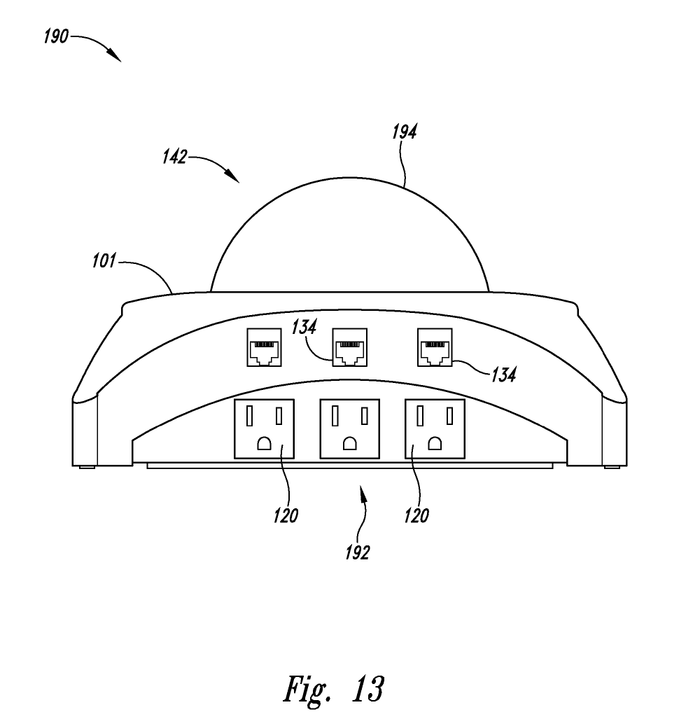

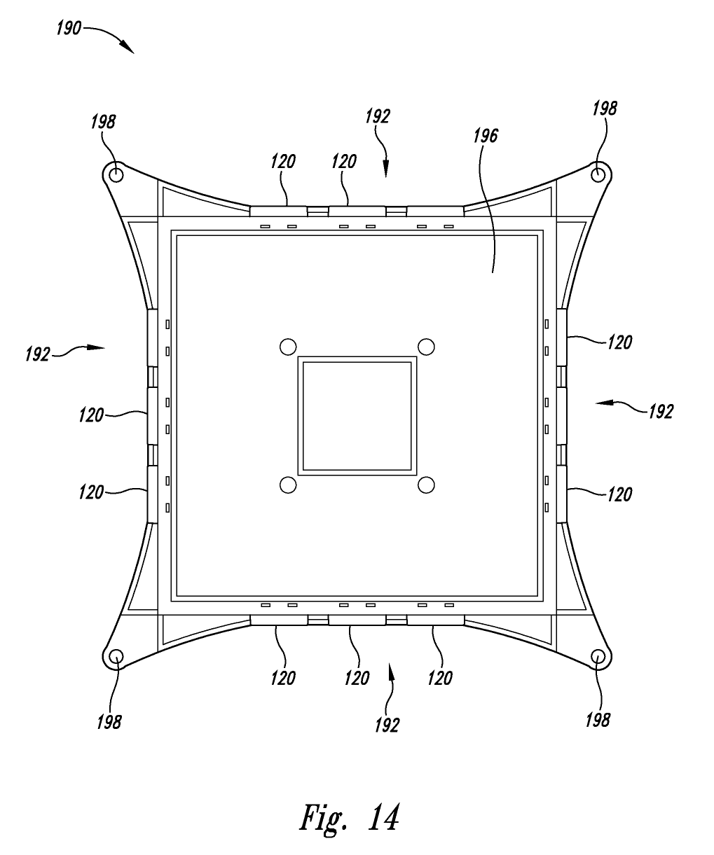

A version of the first implementation 190 is shown in FIG. 9 as including pluralities of the speakers 156, the cameras 158, and the microphones 160. A version of the first implementation 190 including a retractable keypad 206 in an extended position shown in FIG. 10 and a retracted position shown in FIG. 11. A top plan view of the first implementation 190 is shown in FIG. 12. A side elevational view of the first implementation 190 is shown in FIG. 13. A bottom plan view of the first implementation 190 is shown in FIG. 14 is having a bottom surface 196 and legs 198.

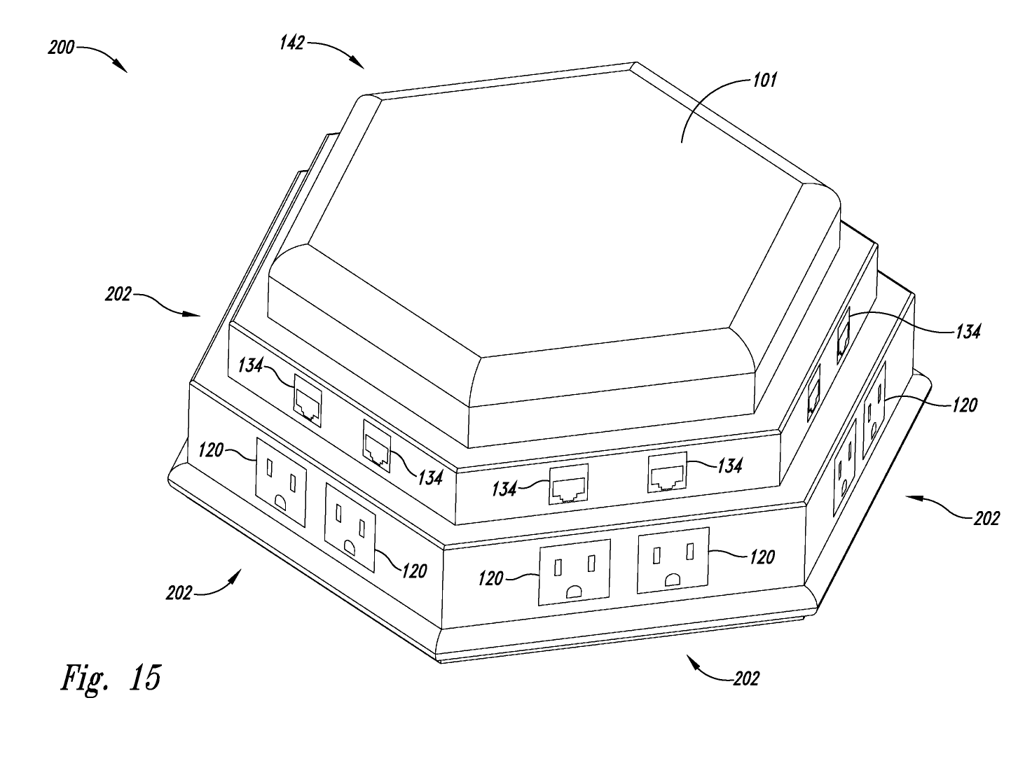

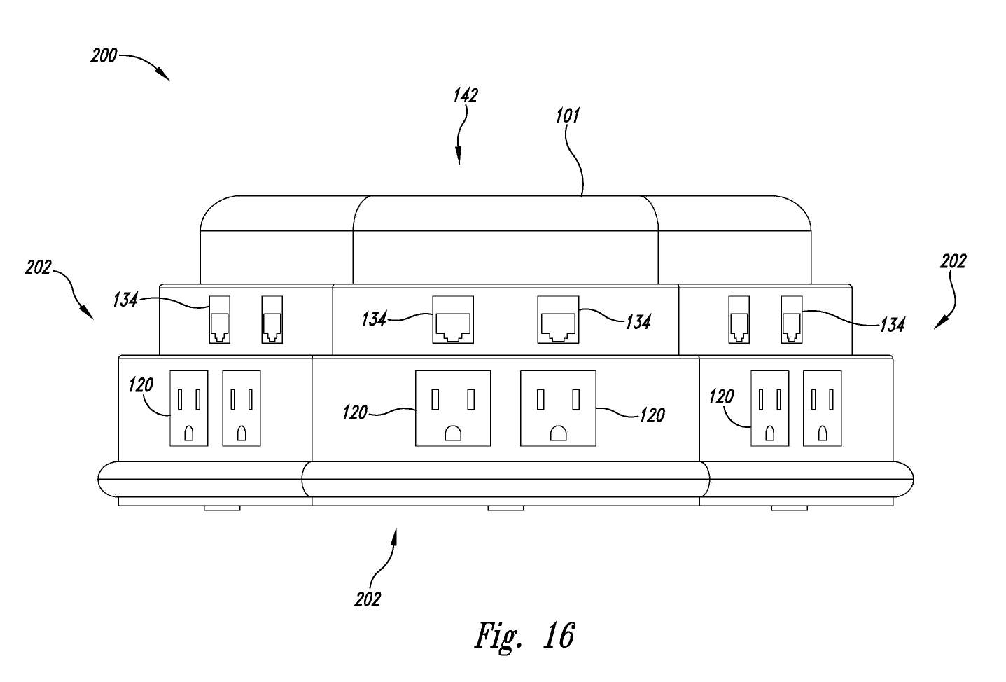

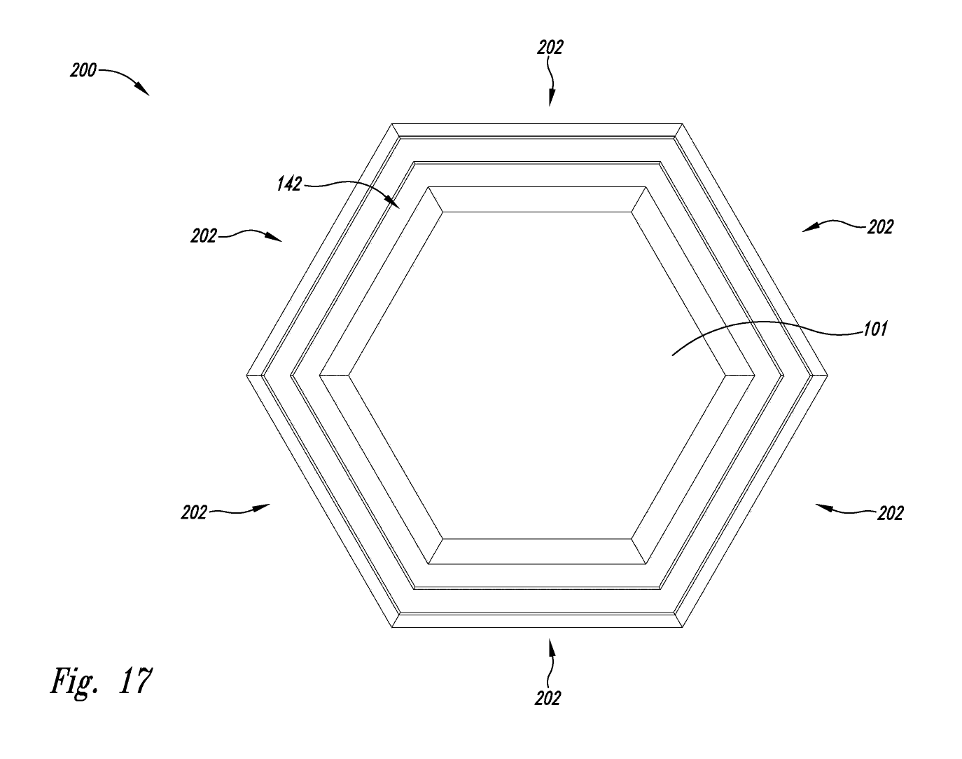

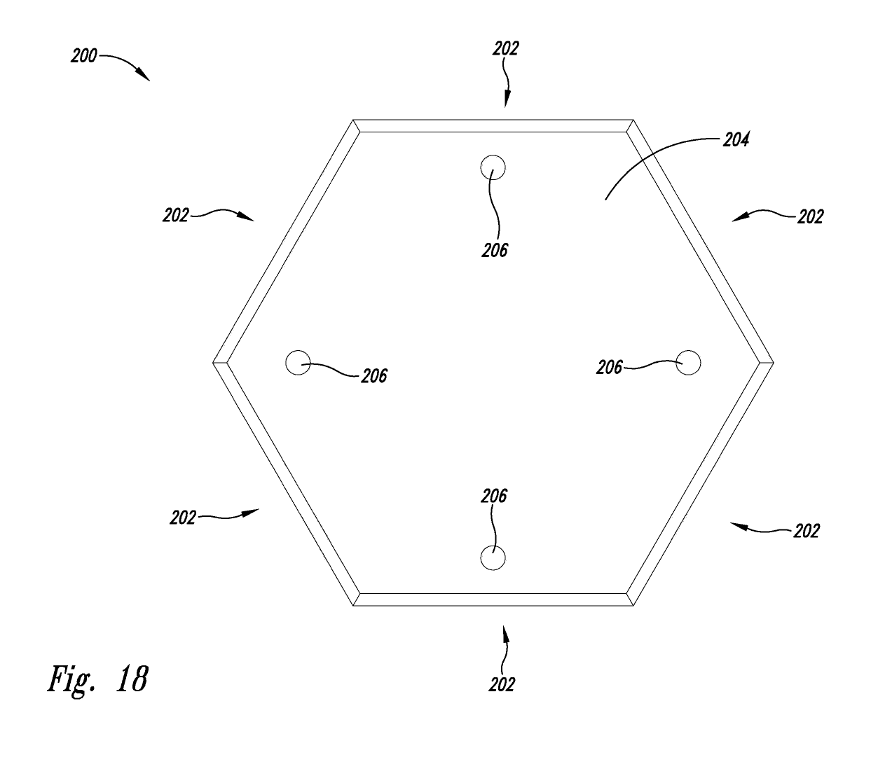

A second implementation 200 is shown in FIGS. 15-18 as a hexagonal structure having six outward facing, opposing bays 202 each with a plurality of the AC outlets 120 and a plurality of the LAN jacks 134 as shown in FIG. 1. As shown in FIG. 18, the second implementation 200 has a bottom surface 204 with legs 206.

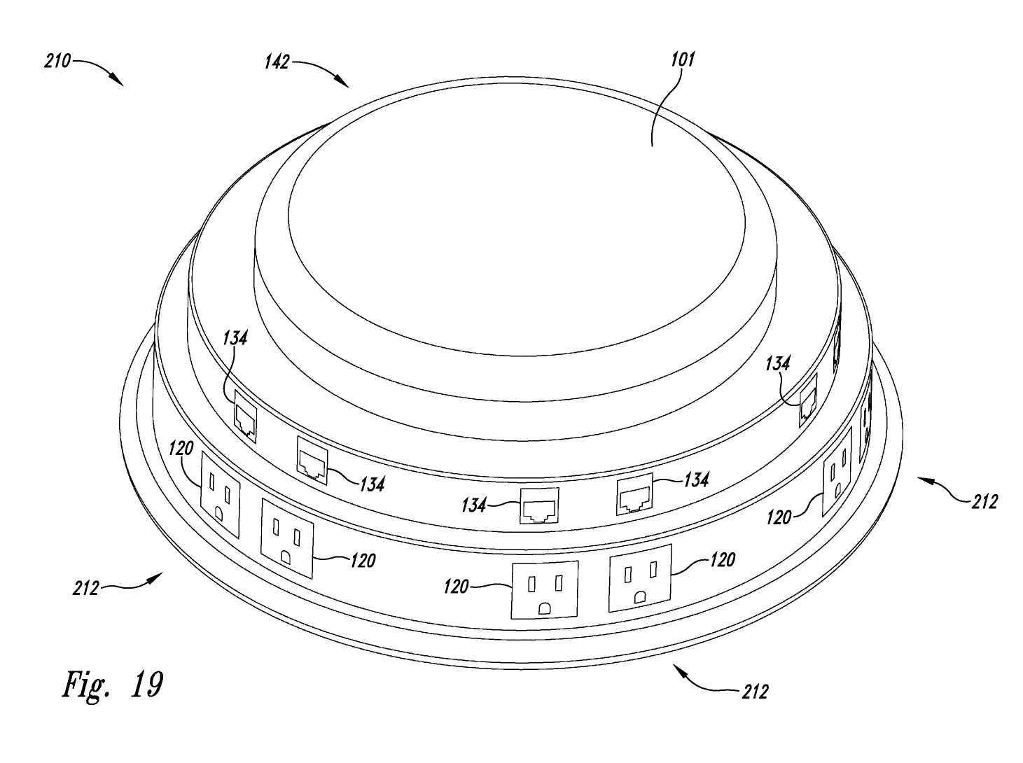

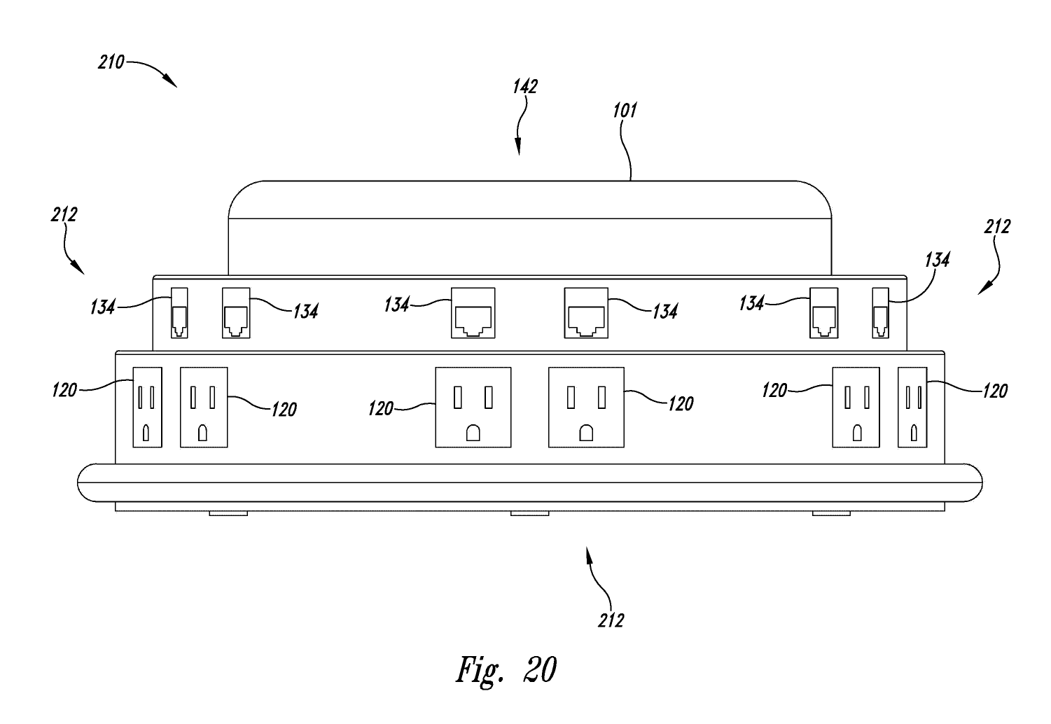

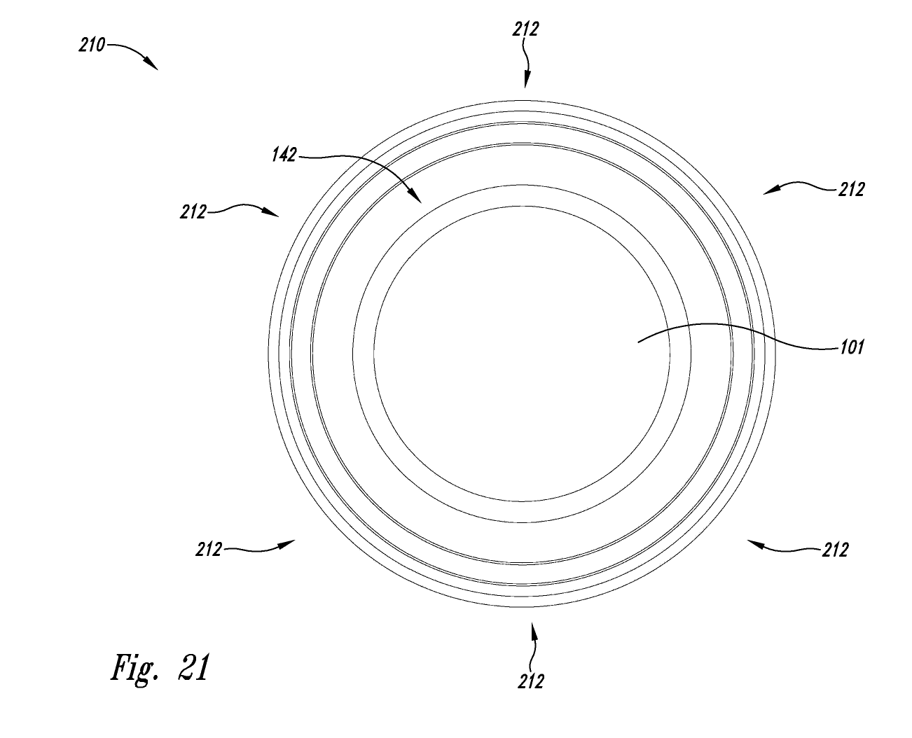

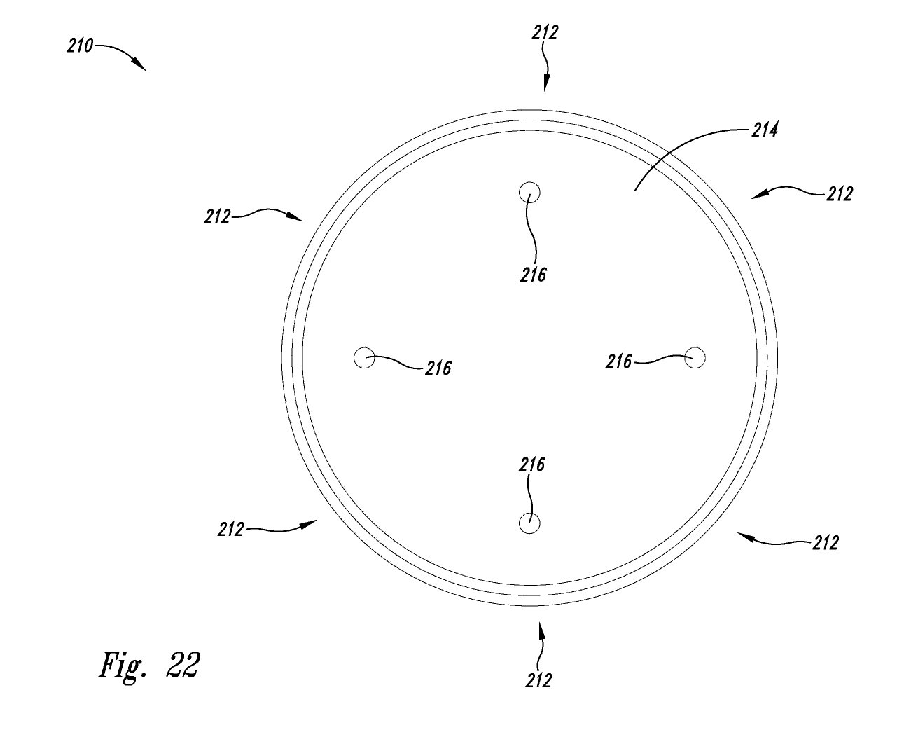

A third implementation 210 is shown in FIGS. 19-22 as a circular structure having a plurality of outward facing, opposing bays 212 each with a plurality of the AC outlets 120 and a plurality of the LAN jacks 134. As shown in FIG. 22, the third implementation 210 has a bottom surface 214 with legs 216.

From the foregoing it will be appreciated that, although specific embodiments of the invention have been described herein for purposes of illustration, various modifications may be made without deviating from the spirit and scope of the invention. Accordingly, the invention is not limited except as by the appended claims.

The invention claimed is

1. For an electrical distribution system linked to a data network through a power line communication bridge, a system comprising:
an enclosure;
an electrical cord configured to electrically couple to the electrical distribution system;
a plurality of electrical outlets supported by the enclosure, the electrical outlets electrically coupled with the electrical cord;
a plurality of network jacks supported by the enclosure;
a wireless interface supported by the enclosure and configured to wirelessly send and receive network communication to wireless devices; and
a power line communication bridge coupled with the enclosure, power line communication bridge communicatively linked to each of the network jacks and to the wireless interface, the power line communication bridge communicatively linked to the electrical cord to send network communication received from the network jacks and the wireless interface to the electrical distribution system over the electrical cord when the electrical cord is electrically coupled to the electrical distribution system and to send network communication received from the electrical distribution system over the electrical cord to the network jacks and the wireless interface when the electrical cord is electrically coupled to the electrical distribution system.

2. The system of claim 1 wherein the network jacks and electrical outlets are grouped into a plurality of bays.

3. The system of claim 1 wherein each of the network jacks are paired with a different one of the electrical outlets in vertical arrangements.

4. The system of claim 1 wherein the network jacks are arranged along a row and the electrical outlets are arranged along another row.

5. The system of claim 1 wherein the enclosure as a dimensional height no great than six inches.

6. The system of claim 1 wherein the enclosure has a dimensional diameter no greater than one foot.

7. The system of claim 6 wherein the bays are outwardly facing.

8. The system of claim 6 wherein one of the bays is opposing another one of the bays.

9. The system of claim 1 further including a bottom surface shaped to be positioned on a planar surface.

10. The system of claim 1 wherein the wireless interface is supported by the enclosure as being removably coupled to the enclosure.

11. The system of claim 1 wherein the wireless interface conforms to at least one of the following wireless protocols families: WiFi, Blue Tooth, and wireless USB.

12. For an electrical distribution system linked to a data network through a power line communication bridge, a system comprising:
an enclosure;
an electrical cord configured to electrically couple to the electrical distribution system;
a plurality of electrical outlets supported by the enclosure, the electrical outlets electrically coupled with the electrical cord;
a plurality of network jacks supported by the enclosure;
a power line communication bridge coupled with the enclosure, the power line communication bridge communicatively linked to each of the network jacks, the power line communication bridge communicatively linked to the electrical cord to send network communication received from the network jacks to the electrical distribution system over the electrical cord when the electrical cord is electrically coupled to the electrical distribution system and to send network communication received from the electrical distribution system over the electrical cord to the network jacks when the electrical cord is electrically coupled to the electrical distribution system, the power line communication bridge including a filter configured to filter signals being sent on to the electrical distribution system when the electrical cord is electrically coupled to the electrical distribution system; and
a power line communication bridge controller linked to the power line communication bridge, the electrical outlets, and the electrical distribution system when the electrical cord is coupled to the electrical distribution system, the power line communication bridge controller having a spectrum analyzer, a spectral relocator, and a bridge filter refinement to determine undesired noise and undesired signals present on the electrical distribution system and the electrical outlets, to instruct the power line communication bridge to change frequency spectrum of outputted signals based upon the spectrum analyzer determination of the presence of the undesired noise and the undesired signals on the electrical distribution system, and to instruct the filter of the power line communication bridge to filter the undesired noise and the undesired signals present from the electrical outlets, respectively.

13. For an electrical distribution system linked to a data network through a power line communication bridge, a system comprising:
an enclosure;
an electrical cord configured to electrically couple to the electrical distribution system;
a plurality of electrical outlets supported by the enclosure, the electrical outlets electrically coupled with the electrical cord;
a plurality of network jacks supported by the enclosure;
an audio speaker; and
a power line communication bridge coupled with the enclosure, the power line communication bridge communicatively linked to each of the network jacks and to the audio speaker, the power line communication bridge communicatively linked to the electrical cord to send network communication received from the network jacks to the electrical distribution system over the electrical cord when the electrical cord is electrically coupled to the electrical distribution system and to send network communication received from the electrical distribution system over the electrical cord to the network jacks and the audio speaker when the electrical cord is electrically coupled to the electrical distribution system.

14. For an electrical distribution system linked to a data network through a power line communication bridge, a system comprising:
an enclosure;
an electrical cord configured to electrically couple to the electrical distribution system;
a plurality of electrical outlets supported by the enclosure, the electrical outlets electrically coupled with the electrical cord;
a plurality of network jacks supported by the enclosure;
an electronic camera; and
a power line communication bridge coupled with the enclosure, the power line communication bridge communicatively linked to each of the network jacks and to the wireless interface, the power line communication bridge communicatively linked to the electrical cord to send network communication received from the network jacks and the electronic camera to the electrical distribution system over the electrical cord when the electrical cord is electrically coupled to the electrical distribution system and to send network communication received from the electrical distribution system over the electrical cord to the network jacks when the electrical cord is electrically coupled to the electrical distribution system.

15. For an electrical distribution system linked to a data network through a power line communication bridge, a system comprising:
an enclosure;
an electrical cord configured to electrically couple to the electrical distribution system;
a plurality of electrical outlets supported by the enclosure, the electrical outlets electrically coupled with the electrical cord;
a plurality of network jacks supported by the enclosure;
a microphone; and
a power line communication bridge coupled with the enclosure, the power line communication bridge communicatively linked to each of the network jacks and to the wireless interface, the power line communication bridge communicatively linked to the electrical cord to send network communication received from the network jacks and the microphone over the electrical cord when the electrical cord is electrically coupled to the electrical distribution system and to send network communication received from the electrical distribution system over the electrical cord to the network jacks when the electrical cord is electrically coupled to the electrical distribution system.

16. For an electrical distribution system linked to a data network through a power line communication bridge, a system comprising:
an enclosure;
an electrical cord configured to electrically couple to the electrical distribution system;
a plurality of network jacks supported by the enclosure;
a wireless interface supported by the enclosure and configured to wirelessly send and receive network communication to wireless devices; and
a power line communication bridge coupled with the enclosure, the power line communication bridge communicatively linked to each of the network jacks and to the wireless interface, the power line communication bridge communicatively linked to the electrical cord to send network communication received from the network jacks and the wireless interface to the electrical distribution system over the electrical cord when the electrical cord is electrically coupled to the electrical distribution system and to send network communication received from the electrical distribution system over the electrical cord to the network jacks and the wireless interface when the electrical cord is electrically coupled to the electrical distribution system.
